(19) United States
(12) Patent Application Publication
(10) Pub. No.: US 2011/0312213 A1
(43) Pub. Date: Dec. 22, 2011

(54) Flat Cable Wiring Structure

(76) Inventor: Akifumi ARAI, Osaka (JP)

(21) Appl. No.: 13/162,089

(22) Filed: Jun. 16, 2011

(30) Foreign Application Priority Data
Jun. 18, 2010 (JP) P.2010-139413

(51) Int. Cl. H01R 12/75; H01B 7/08

(52) U.S. Cl. 439/492; 174/117 F

(57) ABSTRACT

A flat cable wiring structure includes a cable main body and a reinforcement piece. The cable main body includes conductors and an insulating film covering the conductors, and is configured to be wired near portions of a wiring board where leg portion of an electrical component protrudes from a surface of the wiring board. The reinforcement piece is superimposed on a partitioned area of an outer surface of the insulating film. The partitioned area is an area where the outer surface of the insulating film comes into contact with the leg portion in a case where the outer surface of the insulating film comes into contact with the leg portion due to a deformation of the cable main body.

### BACKGROUND

The present invention is related to a flat cable wiring structure, and more particularly, to a flat cable wiring structure where a cable main body formed by covering conductors with an insulating film is wired near portions of a wiring board, where leg portions of an electrical component protrude from the surface, corresponding to the leg portions.

FIG. 5 is a side view showing a partial cross-section of a flat cable 10 that is used in a flat cable wiring structure in the related art. The flat cable 10 includes a cable main body 11 that includes a plurality of conductors 12 and an insulating film 13. The plurality of conductors 12 is disposed parallel to one another, and the insulating film 13 is formed of a resin layer that covers the conductors 12 and has high flexibility. Further, the cable main body 11 is formed in the shape of a wide strap, and can be curved or bent in a curved shape at any position in the longitudinal direction or width direction thereof. Electrodes 14 are formed at one end portion of the cable main body 11 shown in FIG. 5, and the electrodes 14 are connected to solder lands of a wiring board (not shown). Further, insertion electrodes 15 are formed at the other end portion of the cable main body 11, and the insertion electrodes 15 are inserted and connected to the electrodes of a connector (not shown). Furthermore, a reinforcement plate 16 is joined to an area of the cable main body 11 where the insertion electrodes 15 are formed while overlapping with the area of the cable main body 11. Accordingly, the bending rigidity of the cable main body 11 is increased at the portion where the reinforcement plate 16 is joined, by the reinforcement plate 16. Moreover, an adhesive layer 17 is held at one end portion of the cable main body 11. Accordingly, it may be possible to position the electrodes 14 relative to the solder lands of the wiring board by making the adhesive layer 17 adhere to the wiring board. Meanwhile, the above-mentioned electrodes 14 or insertion electrodes 15 are formed at one end portions and the other end portions of the plurality of conductors 12 of the cable main body 11, respectively.

Meanwhile, in the related art, there is a proposal that improves workability when a flat cable is inserted and connected to a connector by joining a reinforcement plate to an end portion of the flat cable while the reinforcement plate overlaps with the end portion of the flat cable (see Patent Document 1). Further, in another related art, there is a proposal that prevents damage to a flat cable, which is caused by bending, by devising the shape or structure of a reinforcement plate that is provided to improve workability when a flat cable is inserted and connected to a connector (see Patent Documents 2 and 3). Furthermore, research for a countermeasure, which prevents damage to a device caused by incorrect insertion of the flat cable into the connector, is also being carried out as disclosed in still another related art (see Patent Document 4).
[Patent Document 1] Japanese Utility Model Publication No. 7-42044 A
[Patent Document 2] Japanese Patent Publication No. 2005-44597 A
[Patent Document 3] Japanese Patent Publication No. 2003-31299 A
[Patent Document 4] Japanese Patent Publication No. 2002-56935 A

### SUMMARY

The flat cable can be used to electrically connect different circuits, which are formed on a wiring board, through use of the ease of the deformation of the flat cable. For example, the flat cable can be advantageously used when a circuit of a vertical wiring board is connected to a circuit of a horizontal wiring board or when a circuit of a wiring board fixed in a fixed position is connected to a circuit of a wiring board assembled with a movable member.

However, as described with reference to FIG. 5, the flat cable includes the cable main body 11 that includes the plurality of conductors 12 disposed parallel to each other and the insulating film 13 covering the conductors 12. Accordingly, the thickness of the insulating film 13, which covers the conductors 12, is reduced in consideration of prevention of the reduction or the like of the deformability or flexibility of the cable main body 11.

Meanwhile, at a portion where the flat cable 10 is wired, the cable main body 11 may often be positioned near a wiring board on which an electrical component is mounted. As the electrical component, an integrated circuit, a transistor, a capacitor, and a resistor are used, for example. Further, if leg portions of the electrical component, for example, end portions of lead wires of the electrical component, leg portions formed by a part of the electrical component, or the like protrude from the surface of the wiring board when the cable main body 11 is positioned near the wiring board on which an electrical component is mounted, there is a concern that the insulating film 13 will be broken or perforated in some cases or the insulating film 13 will be rubbed against the leg portions due to the deformation of the cable main body 11. Such damage, breakage, perforation, or the like causes damage to or the disconnection of the conductor 12 of the cable main body 11.

Moreover, during the assembly that solders the electrodes 14 of the cable main body 11 to the solder lands of the wiring board or inserts and connects the insertion electrodes 15 of the cable main body 11 to the electrodes of a connector (not shown), the insulating film 13 of the cable main body 11 is rubbed against the leg portions. For this reason, there is a concern that the above-mentioned damage, breakage, perforation, or the like of the insulating film 13 will be caused.

Accordingly, the following countermeasures are considered to prevent the occurrence of the damage, breakage, perforation, or the like of the insulating film, which is caused by the rubbing between the insulating film and the leg portions protruding from the surface of the wiring board. One of the countermeasures is to increase the entire thickness of the insulating film. The other countermeasure is to partition in advance an area, which may come into contact with the leg portions as the cable main body is deformed, in the entire area of the outer surface of an insulating film, and to make the thickness of the partitioned area of the insulating film be larger than the thickness of the other areas. If these countermeasures are applied to the cable main body, it may be considered that the damage, breakage, perforation, or the like of the insulating film 13 caused by the rubbing between the insulating film and the leg portions is suppressed. However, according to the former countermeasure, there is a concern that the weight of the cable main body will be increased or that the required deformability or flexibility will not be obtained. Further, according to the latter countermeasure, there is a problem in terms of manufacturing technique since a partial change in the thickness of the insulating film is required.

Meanwhile, the respective Patent Documents 1 to 4 as the related arts disclose only a countermeasure that improves the workability of inserting and connecting the flat cable to a connector and a countermeasure against damage and incorrect insertion of the flat cable caused by the bending of the flat cable, and do not imply any countermeasures that prevent the occurrence of damage, breakage, perforation, or the like of the insulating film that is caused by the rubbing between the insulating film and the leg portions of the electrical component protruding from the surface of the wiring board.

It is therefore one advantageous aspect of the present invention to provide a flat cable wiring structure that can prevent the occurrence of damage, breakage, perforation, or the like of an insulating film, which is caused by the rubbing between the insulating film and leg portions of an electrical component protruding from the surface of a wiring board, without sacrificing to a great extent the deformability or flexibility required for a cable main body or causing problems in terms of the manufacturing technique of the cable main body.

According to one aspect of the invention, there is provided a flat cable wiring structure, comprising:
a cable main body, including conductors and an insulating film covering the conductors, configured to be wired near portions of a wiring board, where leg portion of an electrical component protrudes from a surface of the wiring board; and
a reinforcement piece, superimposed on a partitioned area of an outer surface of the insulating film, the partitioned area being an area where the outer surface of the insulating film comes into contact with the leg portion in a case where the outer surface of the insulating film comes into contact with the leg portion due to a deformation of the cable main body.

The reinforcement piece may be made of a resin piece of which a hardness is higher than a hardness of the insulating film of the cable main body. Further, the resin piece may be joined to the insulating film so as to cross the partitioned area in a width direction of the cable main body.

The flat cable wiring structure may further comprise: electrodes, provided at one end portion of the cable main body, and connected to solder lands of a circuit of the wiring board by soldering; and insertion electrodes, provided at the other end portion of the cable main body, and inserted and connected to electrodes of a connector mounted on another wiring board.

The flat cable wiring structure may further comprise a reinforcement plate, joined to an area of the cable main body where the insertion electrodes are provided while overlapping with the area of the cable main body, so that a bending rigidity of the cable main body is increased. The reinforcement plate and the reinforcement piece may be made of the same kind of resin.

### BRIEF DESCRIPTION OF DRAWINGS

FIG. 1 is a plan view showing a flat cable that is used in a flat cable wiring structure according to the invention.

FIG. 2 is a side view showing a partial cross-section of the flat cable shown in FIG. 1.

FIG. 3 is a schematic side view showing a partial cross-section of a flat cable wiring structure according to an embodiment of the invention. FIG. 4 is an enlarged side view of main parts of FIG. 3.

FIG. 5 is a side view showing a partial cross-section of a flat cable that is used in a flat cable wiring structure in the related art.

### DETAILED DESCRIPTION OF EXEMPLIFIED EMBODIMENTS

Exemplified embodiments of the invention are described below in detail with reference to the accompanying drawings.

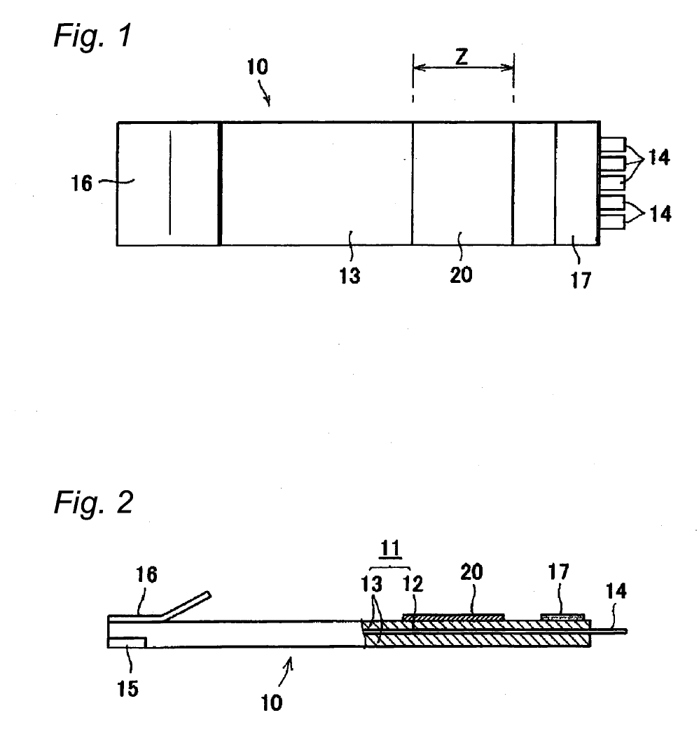

FIG. 1 is a plan view showing a flat cable 10 that is used in a flat cable wiring structure according to the invention, and FIG. 2 is a side view showing a partial cross-section of the flat cable 10 shown in FIG. 1.

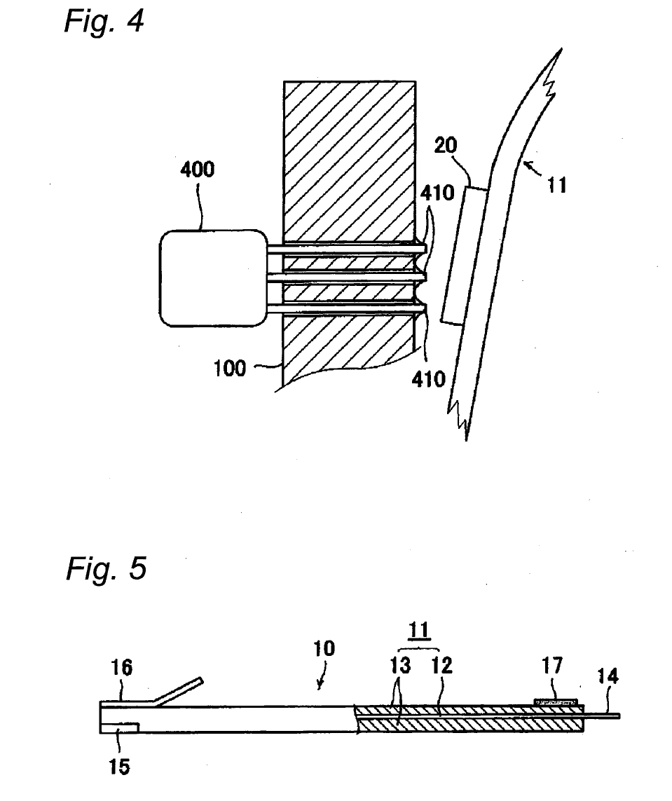

The flat cable 10 shown in FIG. 1 includes a cable main body 11 that is formed in the same manner as described with reference to FIG. 5. Accordingly, the same parts are denoted by the same reference numerals and repeated description thereof will be omitted.

Electrodes 14, which are provided at one end portion of the cable main body 11 of the flat cable 10 shown in FIGS. 1 and 2, are connected to solder lands of a circuit of a wiring board (not shown) by soldering. Further, insertion electrodes 15, which are provided at the other end portion of the cable main body 11, are inserted and connected to electrodes of a connector that is mounted on another wiring board (not shown). When the cable main body 11 of the flat cable 10, of which the point of use is predetermined as described above, is wired near portions of a wiring board, where leg portions of an electrical component protrude from the surface, corresponding to the leg portions, it may be possible to accurately partition an area, which may come into contact with the leg portions due to the deformation of the cable main body 11 during assembly or after the completion of assembly, in the entire area of the outer surface (the entire area including the surface and the back surface) of an insulating film 13 of the cable main body 11.

Accordingly, the area, which may come into contact with the leg portions due to the deformation of the cable main body 11 during assembly or after the completion of assembly, is partitioned and defined on the flat cable 10 shown in FIGS. 1 and 2, and the partitioned area Z is covered with a reinforcement piece 20 that is superimposed on the outer surface of the insulating film 13.

The reinforcement piece 20 is formed of a resin piece of which the hardness is higher than that of the insulating film 13 of the cable main body 11. Specifically, the reinforcement piece 20 is made of the same kind of resin as the material of a reinforcement plate 16. The reinforcement plate 16 is joined to an area of the cable main body 11 where the insertion electrodes 15 are formed while overlapping with the area of the cable main body 11, and serves to increase the bending rigidity of the cable main body 11. Further, each of the reinforcement piece 20 and the reinforcement plate 16 has high surface smoothness or surface slipperiness. Furthermore, the resin piece, which forms the reinforcement piece 20, is disposed so as to cross the partitioned area Z in the width direction of the cable main body 11, and is joined to the insulating film 13 by an adhesive. According to this structure, it is possible to form a flat cable wiring structure according to the invention by adding the reinforcement piece 20 to the flat cable in the related art described with reference to FIG. 5. Further, since the reinforcement piece 20 and the reinforcement plate 16 are made of the same kind of resin, it is advantageous in that the resin used to make the reinforcement piece 20 does not need to be used separately.

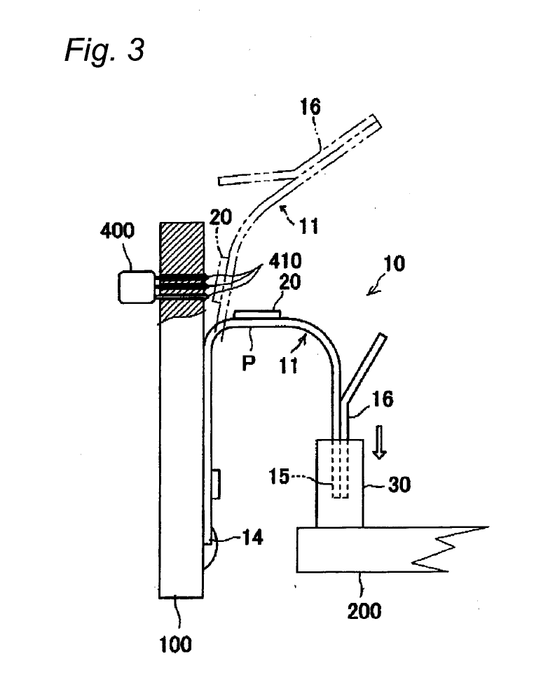

FIG. 3 shows the use form of the flat cable 10 that has the structure described with reference to FIGS. 1 and 2. FIG. 4 is an enlarged side view of main parts of FIG. 3.

In the use form of FIG. 3, the flat cable 10 is used to connect a circuit of a vertical wiring board 100 with a circuit of a horizontal wiring board 200. Specifically, the electrodes 14, which are formed at one end portion of the cable main body 11, are connected to solder lands of a circuit of one wiring board 100 by soldering. Further, the insertion electrodes 15, which are formed at the other end portion of the cable main body 11, are inserted and connected to a connector 30 that is mounted on the other wiring board 200. Furthermore, a middle portion of the cable main body 11 is bent in an inverted U shape, and the portion P, which is bent in the inverted U shape, is wired near protruding portions of leg portions 410 of an electrical component 400 protruding from the surface of the wiring board 100. Not only lead legs of a certain type of electronic component but also leg portions of a rising board or a heat sink may correspond to the leg portions 410 of the electrical component 400.

When the flat cable 10 wired as shown in FIG. 3 is deformed or swung due to vibration or other causes, the reinforcement piece 20 joined to the insulating film 13 of the cable main body 11 is positioned at a position where the reinforcement piece comes into contact with the protruding portions of the leg portions 410 protruding from the surface of the wiring board 100. Further, the reinforcement piece 20 is positioned at a position where the electrodes 14 may come into contact with the leg portions 410 during the assembly that inserts and connects the insertion electrodes 15 of the cable main body 11, of which the electrodes 14 are connected to the solder lands of the circuit of the wiring board 100 by soldering, to the electrodes of the connector 30 of the other wiring board 200.

Accordingly, even though the cable main body 11 is deformed due to certain causes, the reinforcement piece 20 superimposed on the outer surface of the insulating film 13 may be rubbed against the leg portions 410 after the completion of the assembly. For this reason, the insulating film 13 is not directly rubbed against the leg portions 410. Therefore, after the completion of the assembly, there is no room for the generation of damage, breakage, perforation, or the like of the insulating film 13, which is caused by the rubbing between the insulating film 13 and the leg portions 410, and damage to or disconnection of conductors 12 caused by the damage, breakage, perforation, or the like of the insulating film does not occur.

Further, even when the cable main body 11 is bent and the insertion electrodes 15 are inserted and connected to the electrodes of the connector 30 from a step during assembly, for example, a state where the cable main body 11 is positioned at a position very close to the leg portions 410 as shown in FIG. 3 by an imaginary line and shown in FIG. 4 by a solid line, the reinforcement piece 20 superimposed on the outer surface of the insulating film 13 may be rubbed against the leg portions 410. For this reason, the insulating film 13 is not directly rubbed against the leg portions 410. Accordingly, at the steps during the assembly, there is no room for the generation of damage, breakage, perforation, or the like of the insulating film 13, which is caused by the rubbing between the insulating film 13 and the leg portions 410, and damage to or disconnection of the conductors 12 caused by the damage, breakage, perforation, or the like of the insulating film does not occur.

In particular, in the flat cable 10 used in the embodiment, the reinforcement piece 20 is formed of a resin piece of which the hardness is higher than that of the insulating film 13 and surface smoothness and surface slipperiness are high. Accordingly, there is an advantage that there is little concern that the reinforcement piece 20 will be damaged or broken or that the reinforcement piece 20 will be perforated even when the reinforcement piece 20 is rubbed against the leg portions 410. Further, in the flat cable 10 having the above-mentioned structure, the reinforcement piece 20 does not cover the entire area of the outer surface of the insulating film 13 of the cable main body 11 and covers only the partitioned area Z. For this reason, the reinforcement piece 20 does not impair the deformability or flexibility, which is required for the cable main body 11.

As described above, according to the flat cable wiring structure of the invention, it may be possible to prevent the occurrence of damage, breakage, perforation, or the like of the insulating film, which is caused by the rubbing between the insulating film and leg portions of an electrical component protruding from the surface of the wiring board, without sacrificing to a great extent the deformability or flexibility required for the cable main body or causing problems in terms of the manufacturing technique of the cable main body.

What is claimed is:

1. A flat cable wiring structure, comprising:
a cable main body, including conductors and an insulating film covering the conductors, configured to be wired near portions of a wiring board, where leg portion of an electrical component protrudes from a surface of the wiring board; and
a reinforcement piece, superimposed on a partitioned area of an outer surface of the insulating film, the partitioned area being an area where the outer surface of the insulating film comes into contact with the leg portion in a case where the outer surface of the insulating film comes into contact with the leg portion due to a deformation of the cable main body.

2. The flat cable wiring structure according to claim 1, wherein
the reinforcement piece is made of a resin piece of which a hardness is higher than a hardness of the insulating film of the cable main body, and
the resin piece is joined to the insulating film so as to cross the partitioned area in a width direction of the cable main body.

3. The flat cable wiring structure according to claim 2, further comprising:
electrodes, provided at one end portion of the cable main body, and connected to solder lands of a circuit of the wiring board by soldering; and
insertion electrodes, provided at the other end portion of the cable main body, and inserted and connected to electrodes of a connector mounted on another wiring board.

4. The flat cable wiring structure according to claim 1, further comprising:
a reinforcement plate, joined to an area of the cable main body where the insertion electrodes are provided while overlapping with the area of the cable main body, so that a bending rigidity of the cable main body is increased,
wherein the reinforcement plate and the reinforcement piece are made of the same kind of resin.
